(19) United States
(12) Patent Application Publication
(10) Pub. No.: US 2014/0150676 A1
(43) Pub. Date: Jun. 5, 2014

(54) FOOD PREPARATION DEVICE

(71) Applicant: Joni CINQUINI, Burlingame, CA (US)

(72) Inventor: Joni CINQUINI, Burlingame, CA (US)

(21) Appl. No.: 13/693,039

(22) Filed: Dec. 4, 2012

(51) Int. Cl. A47J 17/02

(52) U.S. Cl. CPC A47J 17/02
USPC 99/592; 426/482

(57) ABSTRACT

A food preparation device comprising a container, where the container includes an inner portion to receive a food product; a lid to fit atop the container, where the lid includes a plurality of blades arranged radially across the lid; and a press, where the press pushes the food product against the blades and through the lid into the inner portion of the container, where upon passing the plurality of blades an outer layer is removed from the food product. The food preparation device is used to remove the skin from a head or clove of garlic while avoiding excessive touching or handling the garlic itself.

### BACKGROUND OF THE INVENTION

1. Field of the Invention

The present invention relates to a food preparation tool to remove the outer surface layer of a head or clove of garlic.

2. Description of Related Art

Garlic is one of the most widely used flavor enhancers in cooking. Whether chopped, sliced, minced, roasted, sautéed, used as a seasoning or as a condiment many chefs consider garlic one of the fundamental ingredients to most recipes. Besides being used for cooking, garlic is also known to have medicinal and health benefiting qualities. For example, garlic is known to have antibacterial, antiviral and antifungal properties. People have been eating garlic for centuries enjoying both their delicious flavors and beneficial heath boosting properties.

While garlic is a commonly used product, many individuals find handling garlic messy, smelly and burdensome. Within the garlic clove is a sticky liquid that is encountered once the clove is opened. Some people find this liquid gross to handle and difficult to wash from hands, knives and cutting boards. Often, the liquid causes the smell of garlic to remain on the handling items long after the items are washed. This remnant smell may be off-putting to some individuals causing limited or even nonexistent home garlic use.

To address the problem of sticky liquids or remnant smells a few products have been developed to assist a user when handling garlic. For example, U.S. Pat. No. 5,996,483 by Chung Lun Yip discloses a peeler wherein a hand crank food processor removes the outer skin of garlic and peanuts. The food processor includes a handle which turns an inner blade that removes the skin of the garlic when rolled by the blade. Also, U.S. Pat. No. 7,264,189 by David A. Holcomb and Joshua R. Stewart discloses a hand-held food processor. The processor is an enclosed structure with a pull cord motor for rotating a spindle and arm which in turn peels the garlic.

Still there is a need in the art to provide a tool that will skin a garlic clove or even the whole head with ease. Additionally, it would be desirable in the art to provide a tool that is easy to clean to prevent any remaining garlic from sticking to the tool.

### SUMMARY OF THE INVENTION

In view of the foregoing disadvantages inherent in the prior art, the general purpose of the present invention is to provide a garlic peeler, configured to include all of the advantages of the prior art, and to overcome the drawbacks inherent therein.

Accordingly, an object of the present invention is to provide a food preparation device to remove the outer skin from a head or clove of garlic.

Another object of the present invention is to provide a food preparation device that includes a plurality of blades arranged top the device, where the blades remove the skin from the garlic.

To achieve the above objects, in an aspect of the present invention, a food preparation device is described comprising a container, where the container includes an inner portion to receive a food product; a lid to fit atop the container, where the lid includes a plurality of blades arranged radially across the lid; and a press, where the press pushes the food product against the blades and through the lid into the inner portion of the container, where upon passing the plurality of blades an outer layer is removed from the food product. The food preparation device is used to remove the skin from a head or clove of garlic while avoiding excessive touching or handling the garlic itself.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF THE DRAWINGS

The advantages and features of the present invention will become better understood with reference to the following detailed description and claims taken in conjunction with the accompanying drawing in which:

FIG. 1 depicts a perspective view of a food preparation device is shown in accordance with an exemplary embodiment of the present invention.

### DETAILED DESCRIPTION OF THE DRAWINGS

The present invention relates to a cooking tool to remove the outer surface layer of a head or clove of garlic. The present invention provides a food preparation device to peel garlic without excessive handling or manipulation of the garlic against a user's fingers or cutting board.

The preparation device includes a container to receive the peeled garlic, a lid with radially placed blades to skin the garlic and a press to actually push the garlic through the lid. The press allows manipulation of the garlic without requiring direct skin contact from the user.

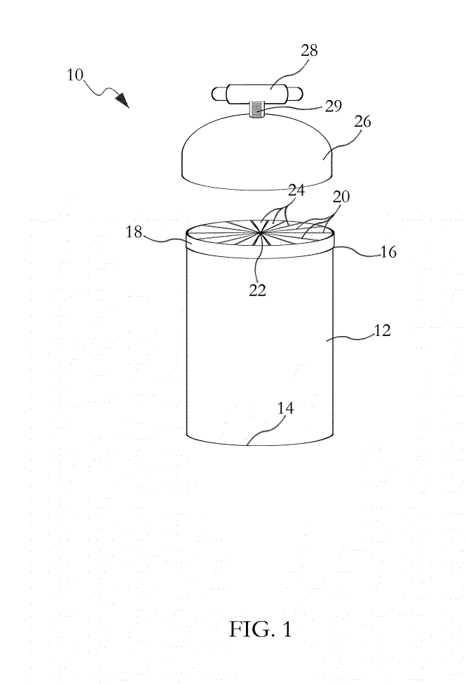

Turning descriptively to the drawing, FIG. 1 is a perspective view of a food preparation device 10 in accordance with an exemplary embodiment of the present invention. The preparation device 10 includes a container 12 and a lid 18 that fits atop the container 18. The container 12 includes a base 14 at the lowermost portion of the container 12 and a rim at the topmost portion. The base 14 is a solid structure to provide a closed bottom for the container 12. The container 12 is open at the rim 16 to enable access into the inner portion of the container 12 without obstructions. The container 12 may be tubular or cylindrical in shape or alternatively cuboidal. The base 14 and the rim 16 are shaped accordingly to the shape of the container 12.

The lid 18 fits snuggly against the rim 16 of the container 12. The lid 18 also is a coordinating shape with the container 12. The lid 18 includes a plurality of blades 20 that are arranged radially across the entire lid 18. The blades 20 bisect each other at a central point 22. The blades 22 may be adjustable or individually removable to accommodate food products of different sizes. The blades 22 may be made out of steel, plastic, aluminum or another material that may be used to form a kitchen slicing tool. The blade material does not rust to enable easy cleaning of the skinning device 10. Between the blades 20 are openings 24, which allow items to pass through the lid 18 and enable access into the inner portion of the container 12 when the lid 18 is in place. When the lid 18 is removed the food product is then easily removed from the inner portion of the container 12.

A press 26 may be used to push the garlic through the blades 22. The bottom of the press 26 is flat so that when the press 26 rests flush atop the lid 18 it securely seals onto the container 12 during use. The press 26 includes a handle 28 for the user to more easily grip the press 26 during use, where the handle 26 includes a spring 29. The spring 29 enables the user to compress the garlic through the blades 22. The press 26 may be weighted to add pressure when pressing the garlic further assisting the user in peeling the garlic skin. The container 12 and the press 26 may be made from plastic, aluminum, wood or another commonly used kitchen container material.

To use the food preparation device 10, first the user may place the lid 18 upon the container 12. Next, they may place a portion of garlic, i.e., a head or clove, upon the lid 18 so that the portion is positioned to go through one or more of the openings 24. The press 26 may then be positioned above the garlic. Finally, the user may push the press 26 against the garlic and the blades 22 to enable the garlic to enter into the inner portion of the container 12. As the garlic passes along the blades 22, the skin from the garlic is removed. The user may then remove the press 26 and lid 18 to access the skinned garlic from the container 12 for cooking enjoyment.

Besides using the food preparation device 10 for garlic other food items like grapes, nuts, oranges and the like may also be used in the skinning device 10. By employing the food preparation device 10 the user does not get their fingers sticky when handling the garlic cloves and their cutting boards are protected from the strong smell and sticky liquid commonly associated with slicing and peeling garlic.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

What is claimed is:

1. A food preparation device comprising:
a. a container, where the container includes an inner portion to receive a food product;
b. a lid to fit atop the container, where the lid includes a plurality of blades arranged radially across the lid; and
c. a press, where the press pushes the food product against the blades and through the lid into the inner portion of the container, where upon passing the plurality of blades an outer layer is removed from the food product.

2. The food preparation device according to claim 1, where the food product is garlic, and where the outer layer is a garlic skin.

3. The food preparation device according to claim 1, where the food product is one of at least grapes, oranges, and nuts.

4. The food preparation device according to claim 1, where the plurality of blades are adjustable.

5. The food preparation device according to claim 1, where the plurality of blades are individually removable.

6. The food preparation device according to claim 1, where the press includes a handle.

7. The food preparation device according to claim 6, where the handle includes a spring.

8. The food preparation device according to claim 1, where the press is weighted.

9. The food preparation device according to claim 1, where the container is cylindrical, and where the lid and press are shaped to match the cylindrical container.

10. A method of using a food preparation device comprising the steps of:
a. placing a food product atop a lid positioned on a container;
b. pushing the food product through a plurality of blades arranged radially within the lid, where the food product is pushed with a press;
c. removing an outer layer from the food product with the plurality of blades; and
d. collecting the food product within the container.

11. The method of use for the food preparation device according to claim 10 further comprising the step of removing the lid after pressing to extract the food product for use in cooking.
